(19) United States
(12) Patent Application Publication
(10) Pub. No.: US 2013/0344336 A1
(43) Pub. Date: Dec. 26, 2013

(54) CHLORINE-DOPED TIN-OXIDE PARTICLES AND MANUFACTURING METHOD THEREFOR

(71) Applicants: Satoshi Mogi, Saitama (JP); Kazuhiko Kato, Saitama (JP); Kenji Suzuoka, Saitama (JP); Yasunori Tabira, Saitama (JP); Isamu Yashima, Saitama (JP)

(72) Inventors: Satoshi Mogi, Saitama (JP); Kazuhiko Kato, Saitama (JP); Kenji Suzuoka, Saitama (JP); Yasunori Tabira, Saitama (JP); Isamu Yashima, Saitama (JP)

(73) Assignee: Mitsui Mining & Smelting Co., Ltd., Tokyo (JP)

(21) Appl. No.: 13/983,660

(22) PCT Filed: Mar. 1, 2012
(86) PCT No.: PCT/JP2012/055270

§ 371 Date: Aug. 5, 2013

(30) Foreign Application Priority Data
Mar. 16, 2011 (JP) 2011-058411

(51) Int. Cl. H01B 1/08

(52) U.S. Cl. CPC H01B 1/08
USPC 428/402; 252/520.1

(57) ABSTRACT

A chlorine-doped tin oxide particle exhibits peaks at at least 108±5 cm⁻¹, 122±5 cm⁻¹, and 133±5 cm⁻¹ in Raman spectroscopy. The chlorine-doped tin oxide particle preferably has an additional Raman spectral peak at 337±10 cm⁻¹. The chlorine-doped tin oxide particle preferably has a specific surface area of 10 to 300 m2/g. The chlorine-doped tin oxide particle preferably has an average primary particle size of 3 to 200 nm. The chlorine-doped tin oxide particle is preferably substantially free of oxygen deficiency.

### TECHNICAL FIELD

This invention relates to a chlorine-doped tin oxide particle and a process for producing the same.

### BACKGROUND ART

It is known that a non-electroconductive material, such as plastics, may be rendered electroconductive by the addition of an electrically conductive powder. Examples of known electroconductive powders include metal powders, carbon black, and tin oxide doped with antimony or a like dopant. Addition of metal powder or carbon black to plastics makes the plastics black, which can limit the utility of the plastics. Addition of tin oxide doped with antimony, etc. makes plastics bluish black, which can also limit the utility of the plastics as with the case of adding carbon black. In addition, using antimony involves the problem of environmental burdens. Hence, various studies have been reported on tin oxide free from an environmentally unsound dopant, such as antimony.

Patent literatures 1 to 3 (see below) propose tin oxide doped with halogen that is an element with low environmental burden. Specifically, patent literature 1 discloses a transparent electroconductive film formed mainly of fluorine- and chlorine-containing tin oxide. Patent literature 2 teaches that tin oxide powder is brought into contact with 10 to 40 vol % fluorine gas in an inert gas atmosphere to provide fluorine-doped tin oxide endowed with electroconductivity. Patent literature 3 discloses transparent tin oxide powder containing 0.3% to 5.0% of fluorine and containing none of antimony, phosphorus, and indium.

### CITATION LIST

### Patent Literature

Patent literature 1: JP 1-236525A
Patent literature 2: JP 2-197014A
Patent literature 3: JP 2008-184373A

### SUMMARY OF INVENTION

### Technical Problem

The tin oxide particles disclosed in the patent literatures cited are not regarded as being sufficient in electroconductivity.

An object of the invention is to provide chlorine-doped tin oxide particles free from various disadvantages of the above described conventional techniques.

### Solution to Problem

The invention provides a chlorine-doped tin oxide particle having peaks at at least 108±5 cm⁻¹, 122±5 cm⁻¹, and 133±5 cm⁻¹ in Raman spectroscopy.

The invention also provides a chlorine-doped tin oxide particle showing, when analyzed for O and Cl by energy dispersive X-ray spectroscopy in an analysis region where the average detected intensity a_{AVG} and the maximum detected intensity a_{MAX} for O satisfy the relation: a_{MAX}<a_{AVG}×3, substantial coincidence between a position p at which the detected intensity a for O is ⅕ or less of the maximum detected intensity a_{MAX} for O in the analysis region and a position q at which the detected intensity b for Cl is ½ or less of the maximum detected intensity b_{MAX} for Cl in the analysis region.

The invention also provides a suitable process for producing the chlorine-doped tin oxide particle. The process includes mixing tin (II) chloride and a basic compound in water to form a chlorine-containing tin precipitate, and firing the precipitate in an oxygen-containing atmosphere.

### Advantageous Effects of Invention

The chlorine-doped tin oxide particle of the invention has high electroconductivity and stable electroconductivity with time.

### BRIEF DESCRIPTION OF DRAWINGS

FIG. 1 shows Raman spectra of the tin oxide particles obtained in Example 1 and Comparative Example 3.

FIG. 2(a) is an transmission electron microscopic image showing a method for deciding the analysis region in identifying the detection positions for O and Cl in a chlorine-doped tin oxide particle by energy dispersive X-ray spectroscopy (hereinafter abbreviated as EDS) and FIG. 2(b) schematically illustrates the direction of line analysis shown in FIG. 2(a).

FIG. 3(a) and FIG. 3(b) are EDS results of the chlorine-doped tin oxide particles obtained in Example 1 showing the positions of detection for O and Cl, respectively.

FIG. 4(a) and FIG. 4(b) are EDS results of the chlorine-doped tin oxide particles obtained in Example 3 showing the positions of detection for O and Cl, respectively.

FIG. 5(a) and FIG. 5(b) are EDS results of the chlorine-doped tin oxide particles obtained in Comparative Example 2 showing the positions of detection for O and Cl, respectively.

### DESCRIPTION OF EMBODIMENTS

The present invention will be described based on its preferred embodiments. The chlorine-doped tin oxide particle of the invention is electroconductive. The object of chlorine doping is to increase electroconductivity of tin oxide particles. The chlorine-doped tin particle of the invention is believed to have a structure in which the oxygen atom of a tin oxide crystal is substituted with a chlorine atom. It is considered that the chlorine-doped tin oxide particle of the invention exhibits the properties of an n-type semiconductor in which electrons are the majority carrier responsible for electric conduction.

The chlorine-doped tin oxide particle of the invention has a structure characterized by peaks in a small wave-number region in Raman spectroscopy, specifically at at least 108±5 cm⁻¹, 122±5 cm⁻¹, and 133±5 cm⁻¹. In other words, the tin oxide particle of the invention exhibits Raman activity. Tin oxide species so far known do not show peaks at the wave-numbers recited above in their Raman spectra. That is, the chlorine-doped tin oxide particle showing peaks at the wave-numbers recited above in their Raman spectra has not been unknown, and the chlorine-doped tin oxide particle of the invention is completely novel.

Some of the chlorine-doped tin oxide particles of the invention show a peak of Raman scattered light at 337±10 cm⁻¹ in addition to the peaks at the first recited wave-numbers. The chlorine-doped tin oxide particles showing such an additional peak at the second recited wave-number exhibit higher electroconductivity than those having peaks at the first recited wave-numbers. The procedures of Raman spectroscopy will be described in Examples given later.

The chlorine-doped tin oxide particles of the invention showing Raman shift peaks at the specific wave-numbers described exhibit higher electroconductivity than tin oxide particles that do not show these peaks. As a result of the inventors' study, it has been revealed that such Raman activity of the chlorine-doped tin oxide particle of the invention disappears on heat-treating the chlorine-doped tin oxide particle. A tin oxide particle having thus lost the Raman activity does not exhibit high electroconductivity any longer but exhibits high electric resistance. The inventors consider from this that the electroconductivity of the chlorine-doped tin oxide particle of the invention is attributed to lattice vibration developing electroconductivity. The aforementioned heat treatment is carried out, for example, at 450° C. or higher for 2 hours or longer in the atmosphere.

The increased electroconductivity of conventionally known electroconductive tin oxide is generally obtained by doping tetravalent tin with a dopant element, such as fluorine, antimony, niobium, or tantalum. In contrast, enhancement of electroconductivity is achieved in the invention by controlling the lattice vibration in chlorine-doped tin oxide that is reflected on the Raman spectrum. Specifically, the Raman activity of the chlorine-doped tin oxide particle of the invention is considered attributable to conductive paths allowing for electroconductivity. Nevertheless, seeing that powder X-ray diffractometry (XRD) reveals no substantial differences between the chlorine-doped tin oxide particle of the invention and so far known tin oxide (SnO₂) particles, it is contemplated that the difference of the chlorine-doped tin oxide particle of the invention from the conventional tin oxide particles consists not in medium- and long-range order of the crystal structure as would be observed in powder XRD but in microstructure such as a short-range order or an interatomic bond. The inventors consider that the carrier mobility increases because of this difference thereby to achieve low resistivity. To adopt this structure allows for increasing the electroconductivity of chlorine-doped tin oxide particles while overcoming the drawbacks of using a dopant element, such as economical disadvantage and large environmental burden.

The chlorine-doped tin oxide particles having Raman activity are obtained by preparing chlorine-doped tin oxide particles in accordance with the hereinafter described process.

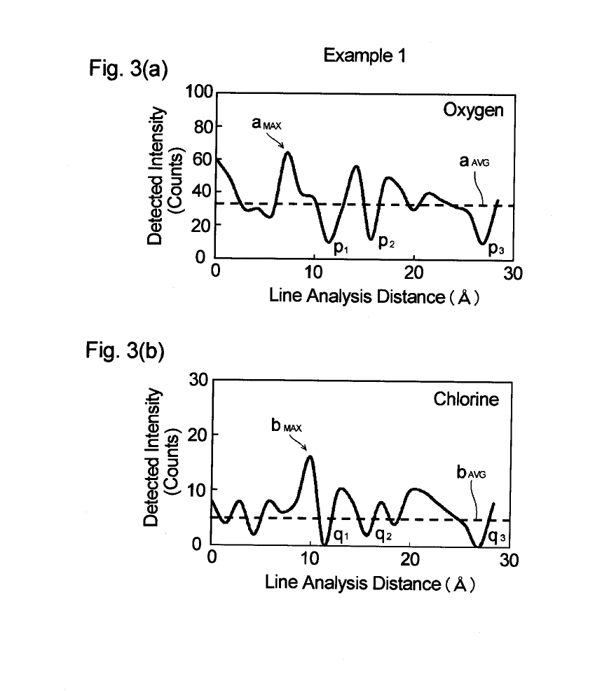

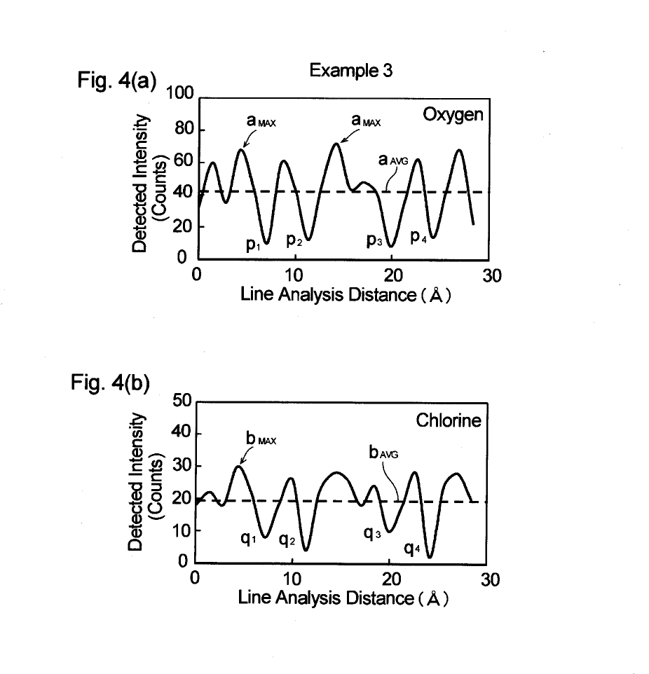

The inventors analyzed the chlorine-doped tin oxide particles having the Raman activity for O and Cl by EDS. It was found as a result, as will be verified with reference to FIGS. 3 and 4, that the detected position p at which the detected intensity a for O is ⅕ or less of the maximum detected intensity a_{MAX} for O and the detected position q at which the detected intensity b for Cl is ½ or less of the maximum detected intensity b_{MAX} for Cl are substantially coincident with each other. This suggests that Cl is dissolved in a solid state at the positions of O in tin oxide, which, the inventors believe, accounts for the increased electroconductivity of the chlorine-doped tin oxide particles of the invention.

The identification of the detected positions p and q for O and Cl, respectively, in EDS is carried out in an analysis region in which the average intensity a_{AVG} and the maximum intensity a_{MAX} for O satisfy the relation: a_{MAX}<a_{AVG}×3. The analysis region satisfying the above condition shows detection intensities with no significant variations, providing high reproducibility of the positional identification. In FIG. 3 hereinafter described, the positions p₁, p₂, and p₃ at which the intensity a is ⅕ or less of the maximum intensity a_{MAX} for O and the positions q₁, q₂, and q₃ at which the intensity b for Cl is ½ or less of the maximum intensity b_{MAX} for Cl are substantially coincident with each other. In FIG. 4, the positions p₁, p₂, p₃, and p₄ at which the intensity a is ⅕ or less of the maximum intensity a_{MAX} for O and the positions q₁, q₂, q₃, and q₄ at which the intensity b for Cl is ½ or less of the maximum intensity b_{MAX} for Cl are substantially coincident with each other. The chlorine-doped tin oxide particle of which the detected position for O and the detected position for Cl are substantially coincident with each other shows the peaks at the above recited wave-numbers in their Raman spectra. As used herein, the phrase “substantially coincident” is intended to means that the absolute difference between the position p for O and the position q for Cl is within 5 Å in terms of the line analysis distance.

In identifying the position p for oxygen, the reason why a position at which the detected intensity a is ⅕ or less of the maximum intensity a_{MAX} is taken as position p is that such a position is composed mainly of a line of Sn with sparse oxygen and is therefore appropriate for detecting oxygen. On the other hand, in identifying the position q for detecting chlorine, the reason why a position at which the detected intensity is ½ or less of the maximum intensity b_{MAX} is taken as position q is as follows. Chlorine existing at the position of O is rare because of its nature of being a dopant and tends to give counts with large variations. Then, in order to reduce such variations of results, the ratio to the maximum detected intensity is made higher than that in the detection of oxygen.

Tin oxide having only divalent tin is, while being electroconductive, black-colored and therefore unable to be used in applications requiring transparency, such as a transparent electroconductive film. Tin oxide having only tetravalent tin is unable to have increased electroconductivity over that of tin oxide having only divalent tin. Contrastingly, the chlorine-doped tin oxide particles of the invention have a whitish color, which allows application to a transparent electroconductive film, and exhibit high electroconductivity, which makes it feasible to provide a transparent electroconductive film with increased electroconductivity. The chlorine-doped tin oxide particles of the invention exhibit similar diffraction peaks to those of tetravalent tin oxide (SnO₂) in powder XRD so that the valence of the tin in the chlorine-doped tin oxide particles of the invention seems to be four for the most part.

The dopant chlorine content in the chlorine-doped tin oxide particles of the invention is preferably 1.0×10⁻³ to 5 mass %, more preferably 5.0×10⁻³ to 2 mass %, relative to the total mass of the chlorine-doped tin oxide, in terms of obtaining increased electroconductivity without impairing economy. The oxygen to tin ratio in the chlorine-doped tin oxide particles is preferably 1.5 to 2.5 mol, more preferably 1.8 to 2.2 mol, of oxygen per mole of tin.

The chlorine-doped tin oxide particle of the invention may contain only chlorine as dopant elements. Alternatively, the chlorine-doped tin oxide particle of the invention may contain other dopant elements in addition to chlorine. Examples of the dopant elements include fluorine. When the chlorine-doped tin oxide particle contains fluorine in addition to chloride as an additional dopant, fluorine, being of the same group as chlorine, substitutes for oxygen in the tin oxide crystals to generate carrier electrons to further reduce the resistance of the chlorine-doped tin oxide particle. From this viewpoint, when the chlorine-doped tin oxide particle contains fluorine in addition to chloride as an additional dopant, the content of fluorine, if any, is preferably 1.0×10⁻³ to 2 mass %, more preferably 5.0×10⁻³ to 1 mass %, relative to the total mass of the chlorine-doped tin oxide particles.

It is said that tin oxide generally should have oxygen deficiency in its crystal structure in order to exhibit electroconductivity. The chlorine-doped tin oxide particle of the invention is, in contrast, substantially free of oxygen deficiency as will be understood from the process of production hereinafter described. To be substantially free of oxygen deficiency brings the advantage of high stability of electric resistance with time. Conventionally known halogen-doped tin oxide particles are produced under conditions that generate oxygen deficiency. Therefore, the halogen is not sufficiently fixed in tin oxide crystals and, as a result, the stability of electric resistance with time appears to be inferior.

The fact that the chlorine-doped tin oxide particles of the invention are substantially free of oxygen deficiency can be confirmed by using as a measure an increase ratio in powder resistivity between before and after a pressure cooker test (hereinafter “PCT”) carried out under the conditions described below. When the increase ratio in powder resistivity before and after the PCT is small, specifically when the powder resistivity increase ratio represented by Rb/Ra, wherein Ra is the powder resistivity of chlorine-doped tin oxide particles before the PCT, and Rb is the powder resistivity of chlorine-doped tin oxide particles after the PCT, is preferably 10 or smaller, more preferably 8 or smaller, the particles are regarded as being substantially free of oxygen deficiency. A PCT is carried out as follows.

Two grams of chlorine-doped tin oxide particles and 1 g of water are sealed in a 30 ml pressure container, and the container is maintained at 180° C. for 3 hours in the atmosphere. After the container cools to room temperature, the particles are taken out, dried in the atmosphere at 80° C. for 2 hours, and subjected to measurement of powder resistivity in accordance with the procedure described later.

Not only does the chlorine-doped tin oxide particle of the invention show a low increase ratio of powder resistivity as stated, the powder resistivity per se of the chlorine-doped tin oxide particle is as low as 10³ Ω·cm or less, preferably 10² Ω·cm or less, more preferably 10¹ Ω·cm or less, at 500 kgf/cm².

The average primary particle size of the chlorine-doped tin oxide particles of the invention is preferably 1 to 5000 nm, more preferably 3 to 3000 nm, even more preferably 3 to 1000 nm, yet even more preferably 3 to 200 nm. The method for measuring the average primary particle size will be described in Examples given later. The particle size of the chlorine-doped tin oxide particles is adjustable by adding an organic compound having a hydroxyl group or adjusting the amount of the compound to be added in the hereinafter described process for producing the particles.

The chlorine-doped tin oxide particles of the invention have a high specific surface area. Specifically, the BET specific surface area of the particles is 10 to 300 m²/g, preferably 10 to 100 m²/g, more preferably 10 to 40 m²/g. The specific surface area of the chlorine-doped tin oxide particles is adjustable by adding an organic compound having a hydroxyl group or adjusting the amount of the compound to be added in the hereinafter described process of production.

The chlorine-doped tin oxide particles of the invention exhibit high transparency when formed into film. For example, a film having a thickness of 2 to 3 μm and containing the chlorine-doped tin oxide particles in an amount of 30 to 80 mass % exhibits very high transparency as having a total transmittance of 85% or more, preferably 90% or more, in the visible light region. The chlorine-doped tin oxide particles of the invention have low transparency to infrared light. For example, a film having a thickness of 2 to 3 μm and containing the chlorine-doped tin oxide particles in an amount of 30 to 80 mass % exhibits high infrared shielding properties as preferably having an infrared transmittance of 80% or less, more preferably 70% or less, at a wavelength of 1500 nm and of 50% or less, more preferably 30% or less, at 2000 nm Film formation and measurement of total visible light transmittance and infrared transmittance will be described in Examples.

A preferred process for producing the chlorine-doped tin oxide particles of the invention is described below. The process includes the steps of mixing tin (II) chloride and a basic compound in water to form a chlorine-containing tin precipitate, and firing the precipitate in an oxygen-containing atmosphere. Each step will hereinafter be described in detail.

An aqueous solution of tin (II) chloride is provided as a starting material. The tin (II) chloride concentration in the aqueous solution is preferably 1.0×10⁻³ to 2.5 mol/l, more preferably 1.0×10⁻² to 1 mol/l. Using tetravalent tin in place of divalent tin only results in the production of highly resistant tin oxide.

Separately from the aqueous solution of tin (II) chloride, an aqueous solution of a basic compound (alkali) is provided. Illustrative examples of the basic compound include alkali metal hydroxides, e.g., sodium hydroxide and potassium hydroxide; alkaline earth metal hydroxides, e.g., magnesium hydroxide; carbonates, e.g., NaHCO₃ and NH₄HCO₃; and ammonia. The basic compound aqueous solution preferably has a hydroxide ion concentration of 1.0×10⁻³ to 6 mol/l, more preferably 1.0×10⁻² to 1 mol/1.

The provided tin (II) chloride aqueous solution and basic compound aqueous solution are mixed to form a precipitate of chlorine-containing tin. To form the precipitate, the tin (II) chloride aqueous solution may be a mother solution, to which the basic compound aqueous solution is fed, or the basic compound aqueous solution may be a mother solution, to which the tin (II) chloride aqueous solution is fed. Whichever serves as a mother solution, the mixing ratio of the tin (II) chloride aqueous solution and the basic compound aqueous solution is preferably 0.1 to 5 mol, more preferably 0.5 to 4 mol, of hydroxide ion per mole of tin (II). Whichever solution is used as a mother solution, the other solution may be added to the mother solution either sequentially in portions or all at once. Addition in portions is preferred in terms of ease of reaction control.

The mixing of the tin (II) chloride aqueous solution and the basic compound aqueous solution is carried out with or without heating. The mixing under heating may be performed by heating the mother solution, for example, to a predetermined temperature and adding thereto the other solution which may be either heated or non-heated. The heating temperature is preferably 30° to 100° C., more preferably 40° to 95° C.

The chlorine-containing tin precipitate formed on mixing the tin (II) chloride aqueous solution and the basic compound aqueous solution is a precursor of desired chlorine-doped tin oxide particles. While the details of the precursor are not clear at present, it appears that the precursor contains tin and oxygen and that the tin is divalent. The molar ratio of tin and oxygen in the precursor is calculated from the amounts of tin and oxygen as determined through chemical analyses such as ICP and gas analysis.

As a result of the inventors' study, it turned out advantageous to add an organic compound having a hydroxyl group to the tin (II) chloride aqueous solution prior to mixing the tin (II) chloride aqueous solution and the basic compound aqueous solution. The presence of a hydroxyl-containing organic compound in the tin (II) chloride aqueous solution allows for broadening the ranges of the divalent tin ion concentration in the tin (II) chloride aqueous solution and the amount of the basic compound aqueous solution to be added. In short, the degrees of freedom of selecting the amounts of tin (II) chloride and the basic compound to be added and the reaction temperature increase. This not only makes it easier to adjust the particle size and specific surface area of the resulting chlorine-doped tin oxide particles but is also effective in minimizing by-production of SnO.

The hydroxyl-containing organic compound may be a low-molecular compound or a high-molecular compound. Examples of the low-molecular, hydroxyl-containing organic compound include monohydric alcohols which may be aliphatic, alicyclic, or aromatic. Examples of useful aliphatic monohydric alcohols include those having 1 to 6 carbon atoms, such as methanol, ethanol, n-butanol, and n-hexanol. Examples of useful alicyclic monohydric alcohols are cyclohexanol and terpineol. Examples of useful aromatic monohydric alcohols include benzyl alcohol.

Illustrative examples of the high-molecular, hydroxyl-containing compound include polyvinyl alcohol and polyols. The polyvinyl alcohol may be non-modified or modified and may be fully or partially (80% to 90%) hydrolyzed polyvinyl alcohol. Examples of modified polyvinyl alcohols include carboxyl-modified, alkyl-modified, acetoacetyl-modified, acrylic acid-modified, methacrylic acid-modified, pyrrolidone-modified, vinylidene-modified, or silanol-modified polyvinyl alcohol. Polyvinyl alcohols [—CH(OH)CH₂—]ₙ with an average degree of polymerization (n) of 200 to 30,000 are preferred, with those in which n=500 to 10,000 being more preferred. The degree of polymerization may be determined by, for example, size exclusion chromatography (SEC). Examples of useful polyols are ethylene glycol, diethylene glycol, triethylene glycol, polyethylene glycol, polypropylene glycol, propanediol, butanediol, pentanediol, hexanediol, glycerol, hexanetriol, butanetriol, and 3-methylpentane-1,3,5-triol. Carbitols are also useful, including methoxyethanol, ethoxyethanol, propoxyethanol, butoxyethanol, methoxyethoxyethanol, ethoxyethoxyethanol, propoxyethoxyethanol, and butoxyethoxyethanol.

In using a monohydric alcohol as a hydroxyl-containing organic compound, its concentration in the tin (II) chloride aqueous solution is preferably 0.005 to 30 mass %, more preferably 0.01 to 10 mass %. When the concentration is within that range, inconveniences such as thickening are prevented from occurring while obtaining sufficient effects of addition of the hydroxyl-containing organic compound, thereby successfully producing chlorine-doped tin oxide particles with uniformity in particle size. In using a high-molecular, hydroxyl-containing organic compound, the concentration is preferably 0.005 to 10 mass %, more preferably 0.01 to 5 mass %, for the same reason.

The ratio of divalent tin to the hydroxyl-containing organic compound in the tin (II) chloride aqueous solution is preferably 0.01 to 150, more preferably 0.03 to 75, in terms of Sn to OH (Sn/OH) molar ratio. Within that range, it is less likely that unreacted Sn ions remain in water and that by-produced tin oxide or oxyhydroxide precipitates.

On mixing the tin (II) chloride aqueous solution and the basic compound aqueous solution, a chlorine-containing tin precipitate forms in the liquid. The liquid sometimes contains by-produced tin oxyhydroxide. To remove the oxyhydroxide, hydrogen peroxide may be added to the reaction system to oxidize the tin oxyhydroxide. Hydrogen peroxide is preferably added in the form of an aqueous solution diluted to a prescribed concentration. The concentration of hydrogen peroxide in the dilute aqueous solution is preferably about 0.1 to 5 mass %. Addition of too much hydrogen peroxide would result in a failure to form desired chlorine-doped tin oxide, only to produce tin dioxide.

The chlorine-containing tin precipitate is collected by filtration and repulped with water to be freed of impurities. After repulping, the precipitate is dried in the atmosphere using a hot air drier and then fired in the atmosphere in a firing furnace to yield desired chlorine-doped tin oxide particles. The firing is preferably carried out at a temperature of preferably 200° to 800° C., more preferably 200° to 700° C., for preferably 0.5 to 24 hours, more preferably 0.5 to 5 hours. Too high firing temperatures would cause chlorine to vaporize only to form tin dioxide.

As remarked above, the firing is performed in the atmosphere, i.e., in an oxygen-containing atmosphere. The firing operation in conventional processes for producing halogen-doped tin oxide particles is usually conducted in an inert atmosphere or a reducing atmosphere in order to generate oxygen deficiency in crystals. In the invention, in contrast, the firing is carried out in an oxidative atmosphere. Understandably, the firing in the invention theoretically generates no oxygen deficiency. That is, the resulting chlorine-doped tin oxide particles are substantially free of oxygen deficiency. The advantages of the chlorine-doped tin oxide particles substantially free of oxygen deficiency are as mentioned previously.

The thus obtained chlorine-doped tin oxide particles are then subjected to a disagglomeration operation using, for example, a media mill, e.g., a bead mill, to a predetermined particle size. The chlorine-doped tin oxide particles after the disagglomeration operation may be dispersed, e.g., in water or an organic solvent using a bead mill, a paint shaker, or the like to provide a transparent monodisperse dispersion. Useful organic solvents include polyhydric alcohols, monohydric alcohols, cellosolves, carbitols, ketones, and mixtures thereof. The concentration of the chlorine-doped tin oxide particles in the transparent dispersion is preferably 0.1 to 50 mass %, more preferably 1 to 40 mass %. The transparent dispersion exhibits high storage stability. The transparent dispersion may be mixed with a binder to provide an ink material.

Examples of the polyhydric alcohols are ethylene glycol, diethylene glycol, triethylene glycol, polyethylene glycol, polypropylene glycol, propanediol, butanediol, pentanediol, hexanediol, glycerol, hexanetriol, butanetriol, 3-methylpentane-1,3,5-triol, and glycerin. Examples of the monohydric alcohols are methanol, ethanol, propanol, pentanol, hexanol, octanol, nonanol, decanol, terpineol, benzyl alcohol, and cyclohexanol. Examples of the carbitols are methoxyethanol, ethoxyethanol, propoxyethanol, butoxyethanol, methoxyethoxyethanol, ethoxyethoxyethanol, propoxyethoxyethanol, and butoxyethoxyethanol. Examples of the ketones are acetone, methyl ethyl ketone, diethyl ketone, methyl isobutyl ketone, and diacetone alcohol.

The chlorine-doped tin oxide particles thus prepared are applicable to a broad range of fields with their high electroconductivity taken advantage of, such as charging rollers, photoreceptor drums, toners, electrostatic brushes, and the like of printers or copiers; flat panel displays, CRTs, Braun tubes, touchscreens, solar cells; coatings, inks, emulsions, and the like. With the high reflectance to infrared radiation being taken advantage of, the chlorine-doped tin oxide particles are also useful as a material of infrared shields.

### EXAMPLES

The invention will now be illustrated in greater detail with reference to Examples, but it should be understood that the scope of the invention is not limited thereto. Unless otherwise noted, all the percentages are given by mass.

### Example 1

In 490 g of pure water was dissolved 4.51 g of sodium hydroxide to prepare a basic aqueous solution, designated solution A. Separately, in a 200 ml beaker containing 100 g of pure water was put 5.0 g of polyvinyl alcohol (average degree of polymerization: 400 to 600; fully hydrolyzed product; hereinafter abbreviated as PVA) and dissolved by heating at 90° C. to prepare a PVA aqueous solution, designated solution B. In a separate beaker was put 390 g of pure water, and 12.57 g of tin dichloride was dissolved therein to prepare a tin aqueous solution, designated solution C. The whole amount of solution B was added to solution C, followed by thoroughly mixing to provide a mother solution, designated solution D.

Solution D was heated to 90° C. while stirring with a paddle stirrer, and the whole amount of solution A was fed thereto using a tube pump. During the feed, the pH of solution D was 3 to 4. After completion of the addition, the mixture was aged for 5 minutes. A solution of 0.75 g of a 30% hydrogen peroxide solution in 30 g of pure water, designated solution E, was then slowly added to the mixture, followed by aging for 5 minutes to form a tin dioxide precursor.

The precursor was collected by filtration through filter paper (Advantec 5C), and the filter cake was washed by pouring 1 liter of pure water. The filter cake was repulped with 1 liter of pure water, followed by filtration, followed by washing by pouring water. These operations were repeated three times to wash the precursor particles. The washed cake was dried in the atmosphere using a hot air drier set at 120° C. for 10 hours and disagglomerated in an agate mortar. The halogen content of the precursor particles was found to be 0.5% chlorine as determined by XRF using ZSX PrimusII from Rigaku Corp. The precursor particles were fired in the atmosphere in an electric furnace at 350° C. for 3 hours to give desired chlorine-doped tin oxide particles.

### Example 2

Chlorine-doped tin oxide particles were obtained in the same manner as in Example 1, except that the mixing of solution A and solution D was carried out at room temperature (about 25° C.) and that solution E (dilute hydrogen peroxide solution) was not added.

### Example 3

Chlorine-doped tin oxide particles were obtained in the same manner as in Example 1, except that solution B (PVA aqueous solution) was not added.

### Comparative Example 1

Comparative Example 1 represents addition of an increased amount of hydrogen peroxide. That is, chlorine-doped tin oxide particles were obtained in the same manner as in Example 1, except for using 7.5 g of a 30% hydrogen peroxide solution diluted with 30 g of pure water as solution E.

### Comparative Example 2

Comparative Example 2 represents an example in which the precursor was fired at an elevated temperature. That is, chlorine-doped tin oxide particles were obtained in the same manner as in Example 1, except for changing the firing conditions to 1000° C. and 3 hours.

### Comparative Example 3

Tin oxide particles (reagent) available from Kojundo Chemical Lab. Co., Ltd. were used.

### Evaluation 1:

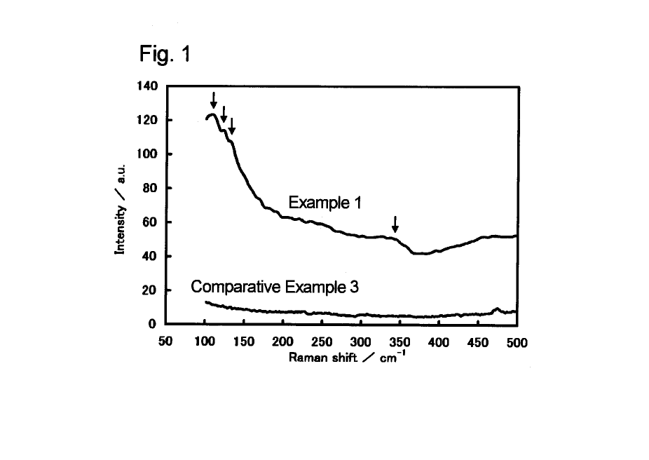

The tin oxide particles obtained in Examples and Comparative Examples were analyzed in terms of chlorine content, structural identification by XRD, elemental analysis (for tin and oxygen), BET specific surface area by nitrogen adsorption, average primary particle size, powder resistivity, total visible light transmittance, and infrared transmittance at 1500 nm in accordance with the methods described below. The results obtained are shown in Table 1. Furthermore, the particles of Example 1 and Comparative Example 3 were subjected to Raman spectroscopy. The results are shown in FIG. 1. Raman spectroscopy was carried out as described below.

### (1) Chlorine Content

Measured using ZSX Primus II from Rigaku Corp.

### (2) XRD

XRD was carried out using RINT-TTRIII from Rigaku Corp. Powder was put in a glass holder dedicated for powder XRD attached to the apparatus and analyzed under the following conditions:

Measuring range: 2θ (deg/CuKα)=from 5° to 80°
Tube voltage: 50 kV
Tube current: 300 mA
Scanning rate: 4°/min

### (3) Elemental Analysis (for Tin and Oxygen)

The tin content was determined using ICP, SPS-3000, from SII NanoTechnology Inc. The oxygen content was determined using a gas analyzer EMGA-620, from Horiba, Ltd. The reason the tin content and the oxygen content in Table 1 do not total 100% resides in the difference of the analysis methods.

### (4) BET Specific Surface Area

Measured using FlowSorb 2300 from Shimadzu Corp. under the following conditions.

Amount of sample powder: 0.3 g
Preliminary degassing: 120° C., 10 minutes in a nitrogen stream

### (5) Average Primary Particle Size

A particle diameter calculated from the BET specific surface area determined in (4) above was taken as an average primary particle size.

### (6) Powder Resistivity

The powder was compressed under a pressure of 500 kgf/cm² to make a sample. The resistivity of the sample was measured by the four-probe resistance method using Lorest PAPD-41 from Mitsubishi Chemical Corp.

### (7) Total Visible Light Transmittance

The chlorine-doped tin oxide particles weighing 7.4 g and 6.4 g of a commercially available acrylic resin were added to 10 g of a toluene/butanol (=7:3 by mass) mixed solvent and dispersed therein with beads in a paint shaker. The resulting dispersion was applied to a PET film and air dried for 1 hour to form a transparent film, the thickness of which was found to be 2 μm as observed using an electron microscope. The total visible light transmittance of the film was determined using a transmission measuring instrument NDH-1001DP from Nippon Denshoku Industries Co., Ltd.

### (8) Infrared Transmittance at 1500 nm

The infrared transmittance of the film prepared in the same manner as described in (7) above was measured using a spectrophotometer U-4000 from Hitachi High-Technologies Corp.

### (9) Raman Spectroscopy

Raman spectroscopy was performed using a laser Raman spectrometer NRS-2100 from JASCO Corp. by microscopic analysis (CCD mode). Light from a laser (λ=514.5 nm; output: 100 mW) was used as exciting light. The Raman spectrum was collected in a range of from 50 to 500 cm⁻¹. The exposure time was 10 seconds. The number of scans was two. The sample was prepared by filling a 10 diameter mold with 0.1 g of the powder and pressing at 1 ton/cm² to make a pellet.

### Evaluation 2:

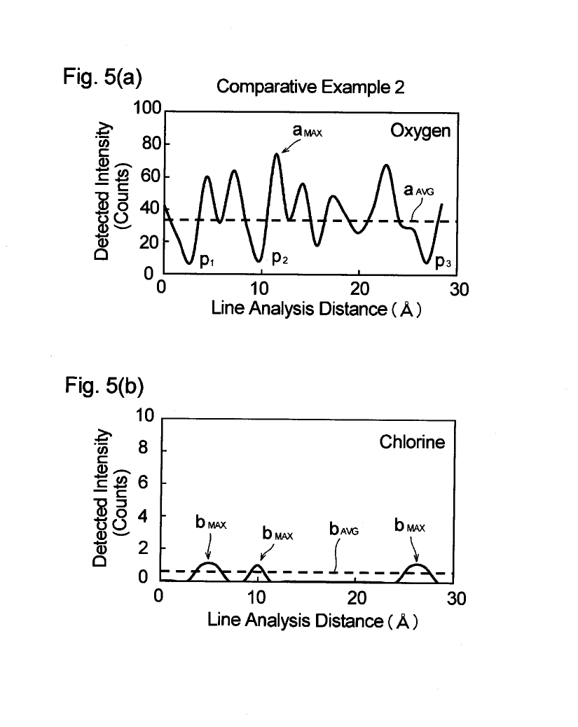

The tin oxide particles obtained in Examples 1 and 3 and Comparative Example 2 were analyzed by EDS to identify the detected positions for oxygen and chlorine. The results are shown in FIGS. 3 to 5. EDS was performed according to the following procedure.

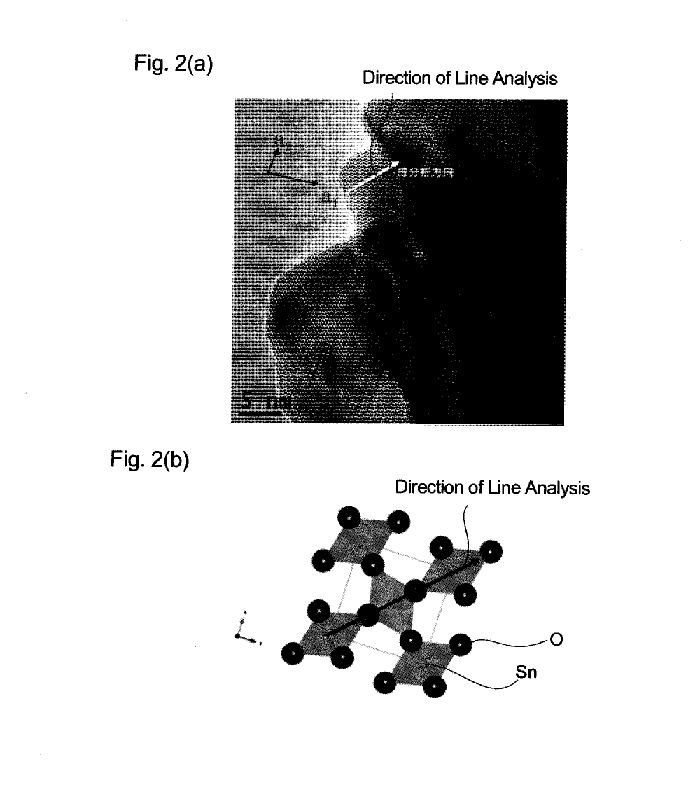

(i) A very small amount of a thoroughly disagglomerated powder was sampled and dispersed in ethanol to prepare a thin dispersion. The particles in the dispersion were caught on a collodion film to prepare a sample for FE-TEM observation.
(ii) The sample was observed under an FE-TEM to locate the position of analysis. In order to decide the position to be analyzed, one non-overlapping single crystal particle that was observable along the c-axis of the crystal was chosen so as to avoid co-presence of Sn and O in the direction perpendicular to the plane of observation.
(iii) Linear analysis was carried out in the direction <110> in which the spacing between Sn and O is the maximum as shown in FIGS. 2(a) and 2(b).

EDS equipment and conditions were as follows.

FE-TEM: JEM-ARM200F, from JEOL, Ltd.
EDS detector: liquid-nitrogen free type SDD detector, from JEOL, Ltd.
Observation mode: STEM mode
Spot size (nominal): 1 Å
Accelerating voltage: 200 kV
Analysis length: about 30 Å
Step width: about 1.4 Å

TABLE 1

| | | Tin Oxide Particles | | | | | | | | | | |
|---|---|---|---|---|---|---|---|---|---|---|---|---|
| | | | | | | BET | Average | PCT Powder | | | Film Evaluation | |
| | Precursor | | | Elemental | | Specific | Primary | Resistivity (Ω · cm) | | | Total | IR |
| | Cl | Cl | | Analysis | | Surface | Particle | Before | After | | Trans- | Trans- |
| | Content | Content | | (mass %) | | Area | size | Heating | Heating | | mittance | mittance |
| | (mass %) | (mass %) | Structure | Sn | O | (m²/g) | (nm) | (Ra) | (Rb) | Rb/Ra | (%) | (%) |
| Example 1 | 3.8 | 0.5 | SnO₂ | 78 | 21 | 15 | 57 | 2 × 10¹ | 1 × 10² | 5 | 84 | 60 |
| Example 2 | 0.5 | 0.3 | SnO₂ | 79 | 20 | 20 | 43 | 2 × 10⁰ | 1 × 10¹ | 7 | 90 | 65 |
| Example 3 | 0.5 | 0.3 | SnO₂ | 78 | 22 | 14 | 61 | 2 × 10¹ | 9 × 10¹ | 5 | 88 | 68 |
| Comp. | ND | ND | SnO₂ | 78 | 21 | 60 | 14 | 5 × 10⁴ | 7 × 10⁵ | 14 | 90 | 82 |
| Example 1 | | | | | | | | | | | | |
| Comp. | 0.4 | ND | SnO₂ | 79 | 21 | 7 | 122 | 1 × 10⁵ | 3 × 10⁵ | 3 | 71 | 65 |
| Example 2 | | | | | | | | | | | | |
| Comp. | ND | ND | SnO₂ | 79 | 21 | 2 | 429 | 4 × 10⁵ | 6 × 10⁵ | 2 | 55 | 52 |
| Example 3 | | | | | | | | | | | | |

ND: Not-detected

As is apparent from the results shown in FIG. 1, the chlorine-doped tin oxide particles of Example 1 show peaks in a small wave-number region in Raman spectroscopy. These peaks appears at about 108 cm⁻¹, about 122 cm⁻¹, about 133 cm⁻¹, and about 337 cm⁻¹. In contrast, the particles of Comparative Example 3 do not show such peaks. The chlorine-doped tin oxide particles obtained in other Examples exhibited similar Raman spectra while not shown in FIG. 1.

As is clear from the results in FIGS. 3 to 5, the chlorine-doped tin oxide particles of Examples 1 and 3 show substantial coincidence between the position p₁ of detected O and the position q₁ of detected Cl, indicating that Cl is dissolved in solid state in tin oxide at the position of O. On the other hand, the particles of Comparative Example 2 revealed to have no Cl detected at the positions p₁ of 0.

As can be seen from the results in Table 1, the chlorine-doped tin oxide particles obtained in Examples prove to have high electroconductivity, high visible light transmission, and a large specific surface area. The results also prove that these particles exhibit good results in the PCT. It should be noted that the particles of Comparative Examples 2 and 3 give satisfactory results in the PCT owing to being free of oxygen deficiency but their resistivity per se is high on account of being free of oxygen deficiency. In addition, the particles of Comparative Examples 2 and 3 in film form have low total light transmission due to their small BET specific surface area, namely large particle size.

1. A chlorine-doped tin oxide particle having peaks at at least 108±5 cm⁻¹, 122±5 cm⁻¹, and 133±5 cm⁻¹ in Raman spectroscopy.

2. The chlorine-doped tin oxide particle according to claim 1, further having a Raman spectral peak at 337±10 cm⁻¹.

3. A chlorine-doped tin oxide particle showing, when analyzed for O and Cl by energy dispersive X-ray spectroscopy in an analysis region where the average detected intensity a_{AVG} and the maximum detected intensity a for O satisfy the relation: a_{MAX}<a_{AVG}×3, substantial coincidence between a position p at which the detected intensity a for O is ⅕ or less of the maximum detected intensity a for O in the analysis region and a position q at which the detected intensity b for Cl is ½ or less of the maximum detected intensity b_{MAX} for Cl in the analysis region.

4. The chlorine-doped tin oxide particle according to claim 1, having a specific surface area of 10 to 300 m²/g.

5. The chlorine-doped tin oxide particle according to claim 1, having an average primary particle size of 1 to 5000 nm.

6. The chlorine-doped tin oxide particle according to claim 1, being substantially free of oxygen deficiency.

7. The chlorine-doped tin oxide particle according to claim 1, showing, when analyzed for O and Cl by energy dispersive X-ray spectroscopy in an analysis region where the average detected intensity a_{AVG} and the maximum detected intensity a_{MAX} for O satisfy the relation: a_{MAX}<a_{AVG}×3, substantial coincidence between a position p at which the detected intensity a for O is ⅕ or less of the maximum detected intensity a_{MAX} for O in the analysis region and a position q at which the detected intensity b for Cl is ½ or less of the maximum detected intensity b_{MAX} for Cl in the analysis region.

8. A process for producing a chlorine-doped tin oxide particle, comprising mixing tin (II) chloride and a basic compound in water to form a chlorine-containing tin precipitate and firing the precipitate in an oxygen-containing atmosphere.

9. The process according to claim 8, wherein an organic compound having a hydroxyl group is further mixed with the tin (II) chloride and the basic compound.

10. The chlorine-doped tin oxide particle according to claim 3, having a specific surface area of 10 to 300 m²/g.

11. The chlorine-doped tin oxide particle according to claim 3, having an average primary particle size of 1 to 5000 nm.

12. The chlorine-doped tin oxide particle according to claim 3, being substantially free of oxygen deficiency.
